(19) United States
(12) Patent Application Publication
(10) Pub. No.: US 2013/0206538 A1
(43) Pub. Date: Aug. 15, 2013

(54) Actuator Seal with Lubricating Gaps

(71) Applicant: Robert Pecak, Naperville, IL (US)

(72) Inventor: Robert Pecak, Naperville, IL (US)

(21) Appl. No.: 13/516,621

(22) PCT Filed: Dec. 9, 2010
(86) PCT No.: PCT/US10/59737

§ 371 Date: Aug. 31, 2012

Related U.S. Application Data
(60) Provisional application No. 61/284,531, filed on Dec. 18, 2009.

(51) Int. Cl. F16J 9/12; F16D 25/06

(52) U.S. Cl. CPC F16J 9/12; F16D 25/06
USPC 192/85.17; 277/436

(57) ABSTRACT

A seal is for sealing a clearance space between first and second members disposed generally coaxially about an axis, one of the two members being linearly displaceable generally along the axis relative to the other one of the two members. The seal includes a generally annular body coupled with the first member, the body having a centerline generally coaxial with the central axis, a sealing surface extending circumferentially about the axis, and a plurality of projections extending generally radially from the sealing surface and into contact with the second member. The projections are spaced circumferentially about the axis so as to define a separate lubrication gap between each pair of adjacent projections. The body is configured to radially deflect when exposed to at least a predetermined fluid pressure such that recessed sections of the sealing surface extending between the projections contact the second member to substantially obstruct the clearance space.

The present invention relates to seals, and more particularly to seals for actuator piston assemblies.

Actuator assemblies for mechanisms such as clutches are generally known and often include a piston coupled with an input member (e.g., an input shaft) and a means for displacing the piston, such as a hydraulic working fluid, a solenoid, etc. Typically, the piston linearly displaces along an axis to engage or disengage a clutching mechanism that operatively couples the input member with an output member. When the piston is driven by hydraulic pressure, one or more seals are required to retain the hydraulic fluid (e.g., automatic transmission fluid) within one or more pressure chambers used to drive the piston.

### SUMMARY OF THE INVENTION

In one aspect, the present invention is a seal for sealing a clearance space between first and second members disposed generally coaxially about an axis, one of the first and second members being linearly displaceable generally along the axis relative to the other one of the first and second members. The seal comprises a generally annular body coupled with the first member, the body having a centerline generally coaxial with the central axis, a sealing surface extending circumferentially about the axis, and a plurality of projections extending generally radially from the sealing surface and into contact with the second member. The projections are spaced circumferentially about the axis so as to define a separate lubrication gap between each pair of adjacent projections. Further, the body is configured to radially deflect when exposed to at least a predetermined fluid pressure such that recessed sections of the sealing surface extending between the projections contact the second member to substantially obstruct the clearance space.

In another aspect, the present invention is an actuator assembly comprising first and second members disposed coaxially about a central axis such that a clearance space is defined between the two members, one of the first and second members being an actuator piston linearly displaceable generally along the axis relative to the other one of the first and second members. A seal is provided for sealing the clearance space and includes a generally annular body coupled with the first member, the body having a centerline generally coaxial with the central axis a sealing surface extending circumferentially about the axis, and a plurality of projections extending generally radially from the sealing surface and into contact with the second member. The projections are spaced circumferentially about the axis so as to define a separate lubrication gap between each pair of adjacent projections. The body is configured to radially deflect when exposed to at least a predetermined fluid pressure such that recessed sections of the sealing surface extending between the projections contact the second member to substantially obstruct the clearance space.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view of an actuator assembly having three seals in accordance with the present invention;

FIG. 2 is a perspective view from the bottom of a balance piston having one of the seals;

FIG. 3 is a broken-away, enlarged perspective view from the top of a portion of the seal shown in FIG. 2;

FIG. 4 is a broken-away, greatly enlarged perspective view of the seal of FIG. 2, showing angled projections;

FIG. 5 is a broken-away, greatly enlarged, radial cross-sectional view through the seal, shown in a relatively low pressure state;

FIG. 6 is another view of the seal of FIG. 5, shown in a relatively high pressure state;

FIG. 7 is a broken-away, enlarged cross-sectional view of another actuator assembly having three seals of the present invention;

FIG. 8 is a broken-away, greatly enlarged view of a portion of FIG. 7, showing an outer seal between a balance piston and an actuating piston;

FIG. 9 is a broken-away, greatly enlarged view of another portion of FIG. 7, showing an outer seal between the actuating piston and a housing; and

FIG. 10 is a broken-away, greatly enlarged view of yet another portion of FIG. 7, showing an inner seal between the actuating piston and an input shaft.

### DETAILED DESCRIPTION OF THE INVENTION

Certain terminology is used in the following description for convenience only and is not limiting. For example, the word “connected” is intended to include direct connections between two members without any other members interposed therebetween and indirect connections between members in which one or more other members are interposed therebetween. The terminology includes the words specifically mentioned herein, derivatives thereof, and words of similar import.

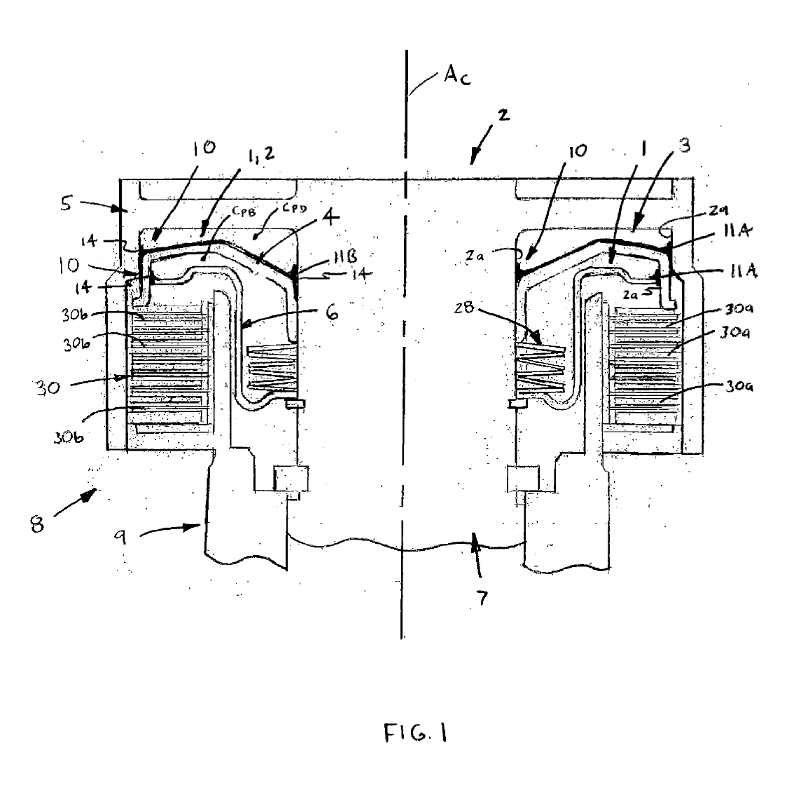

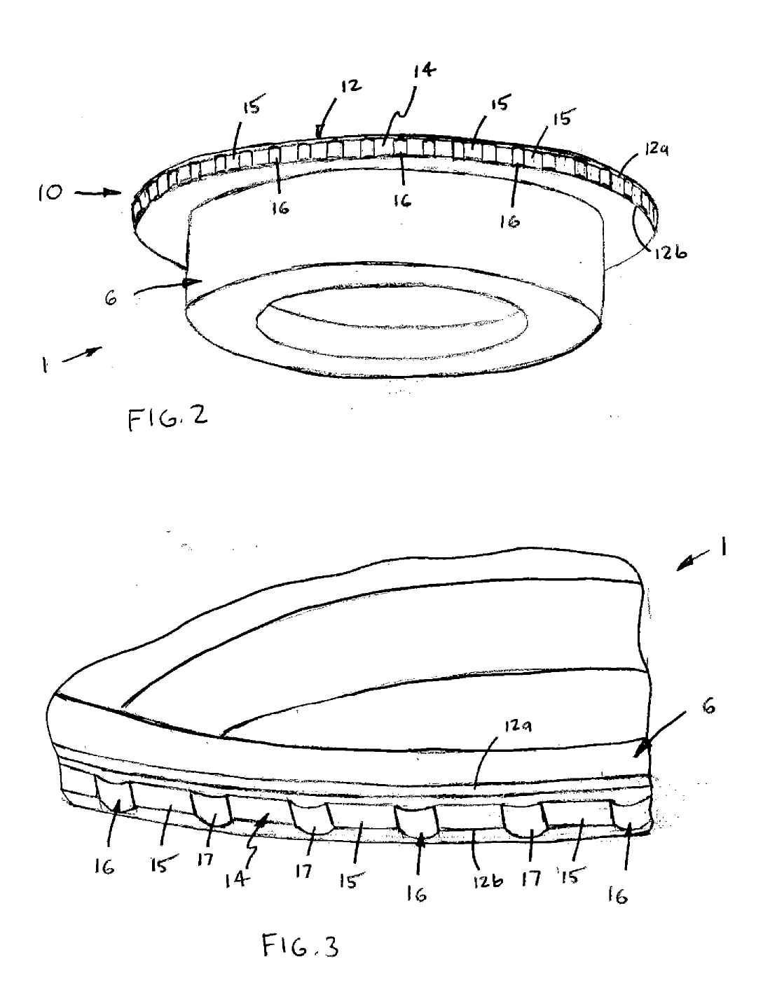

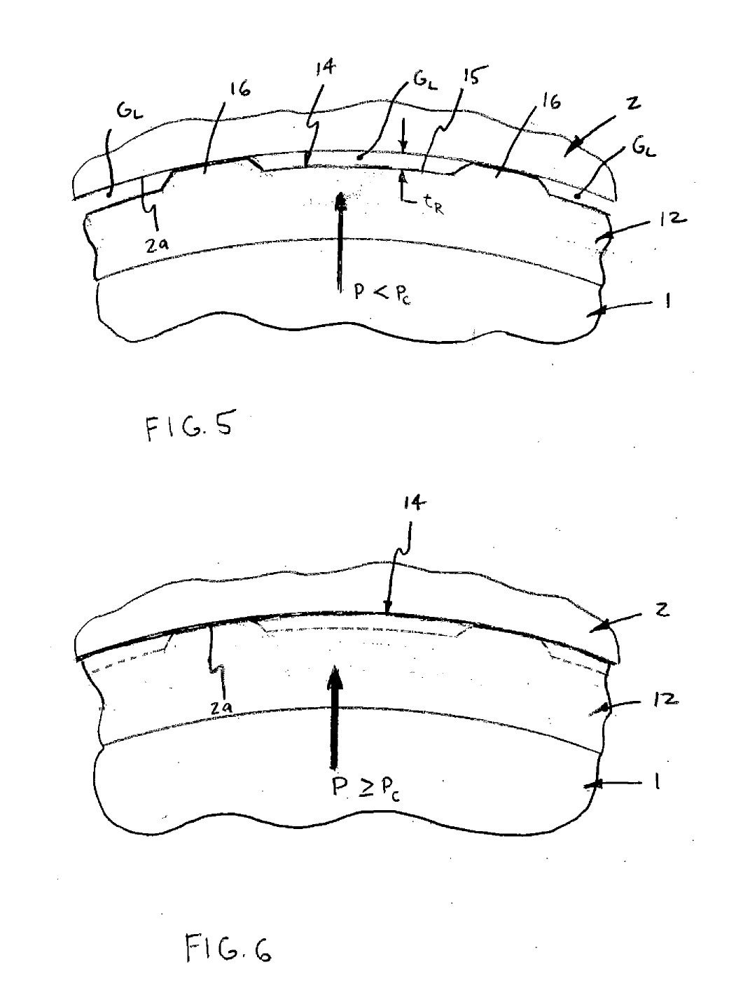

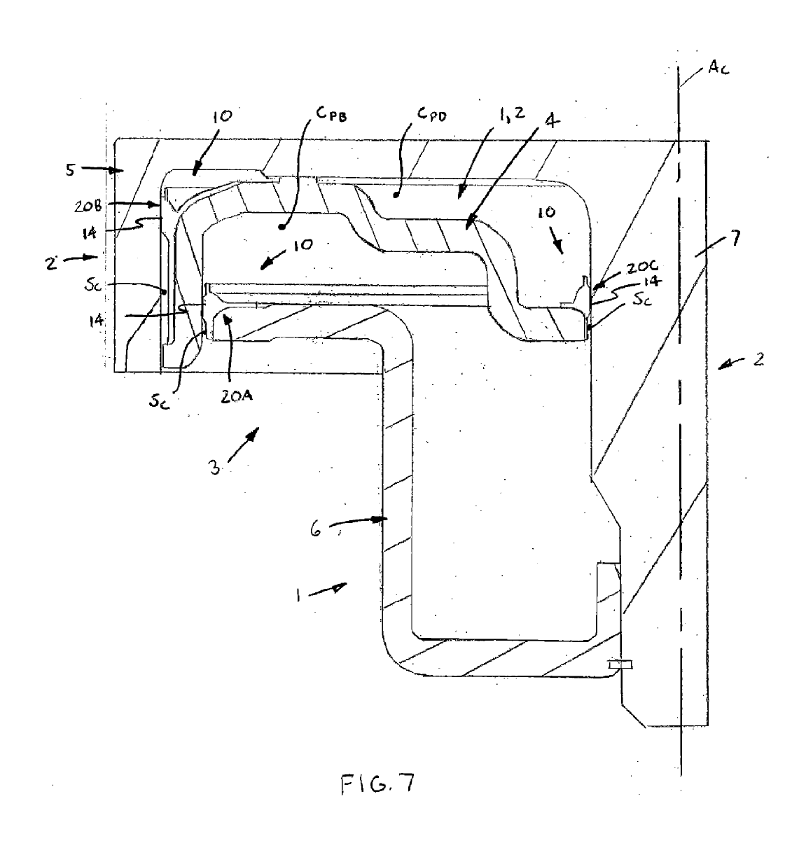

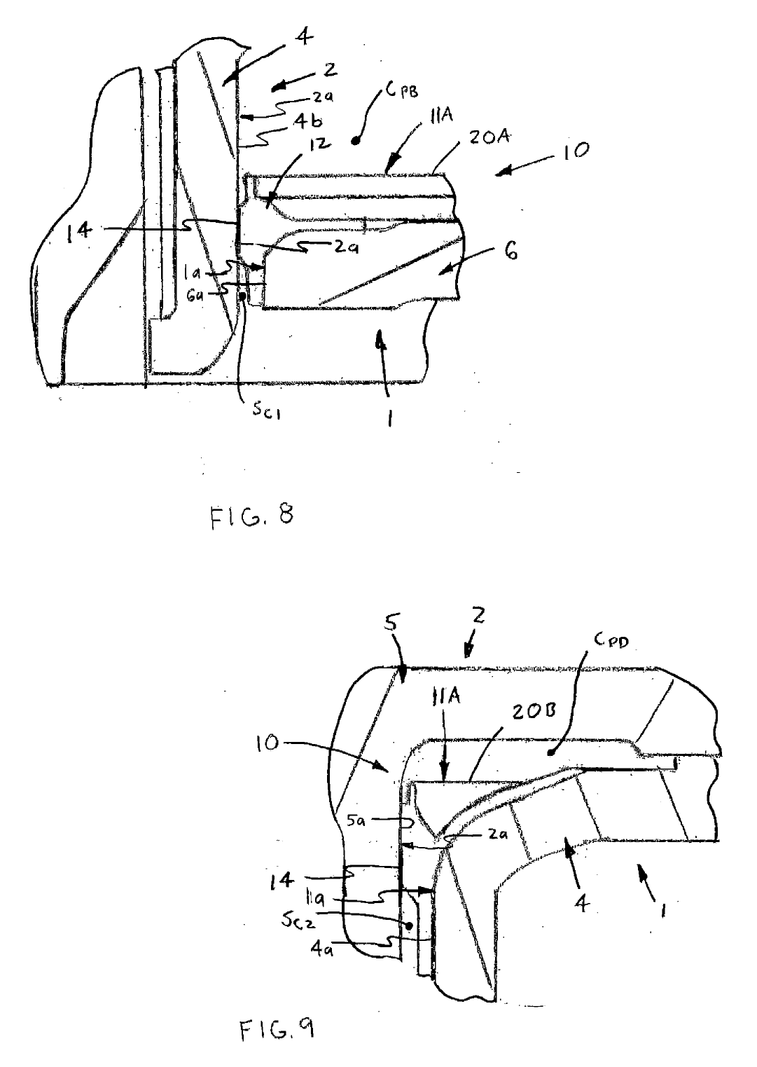

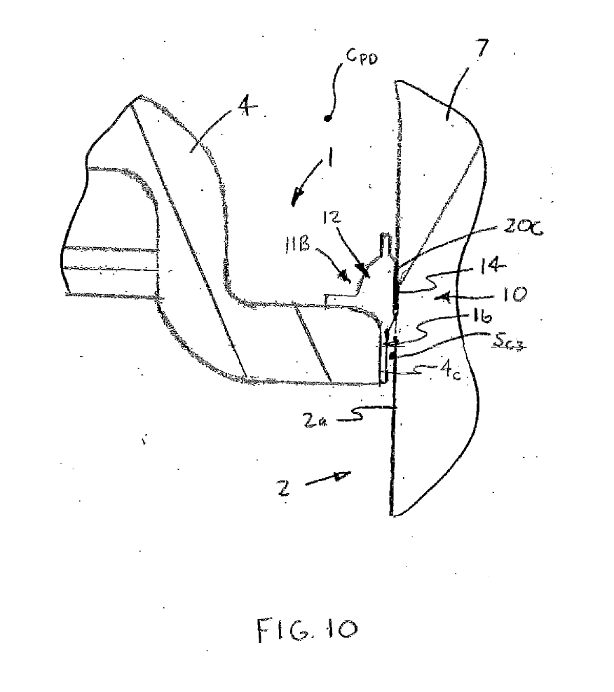

Referring now to the drawings in detail, wherein like numbers are used to indicate like elements throughout, there is shown in FIGS. 1-10 a seal 10 for sealing a clearance space S_{C} (FIGS. 7-10) between first and second members 1, 2, respectively, of an actuator assembly 3. The two members 1, 2 are disposed generally coaxially about a central axis A_{c} and one of the first and second members 1, 2 is linearly displaceable generally along the axis A_{C} relative to the other one of members 1, 2, the displaceable member 1 or 2 preferably being a clutch actuating piston 4, as described below. The seal 10 basically comprises a generally annular body 12 coupled with the first member 1, the body 12 having a centerline (not indicated) generally coaxial with the central axis A_{C} and a sealing surface 14 extending circumferentially about the axis A_{C}. A plurality of projections 16 extend generally radially from the sealing surface 14 and into contact with the second member 2. The projections 16 are spaced circumferentially about the axis A_{C} so as to define a separate lubrication gap G_{L} (FIG. 5) between each pair of adjacent projections 16. Further, the seal body 12 is configured to radially deflect when exposed to at least a predetermined “closure” fluid pressure P_{C}, such that recessed sections 15 of the sealing surface 14 extending between the projections contact the second member to substantially obstruct the clearance space S_{C}.

More specifically, a pressure chamber C_{P} is preferably defined generally between the first and second members 1, 2 and the seal body 12 is exposed to pressure P of a fluid within the chamber C_{P}. Each lubrication gap G_{L} is configured to permit a lubricant, preferably a portion of a working fluid as described below, to become disposed, e.g., by seepage, limited flow, etc., generally between the sealing surface 14 and the second member 2 when the seal body 12 is exposed to a pressure P lesser than the predetermined, closure pressure P_{C}. Such a relatively lesser or low pressure situation may occur when the actuator assembly 3 is in an inactive or non-operational state.

However, when the actuator assembly 3 becomes operational, i.e., the pressure P of the fluid increases to level sufficient to cause displacement of the moveable member 1 or 2, the seal body 12 deflects radially after the pressure reaches the predetermined pressure (i.e., P≧P_{C}) to “seal” the clearance space S_{C}, as indicated in FIG. 6. That is, the body 12 expands obstruct or occupy the lubrication gaps G_{L}, such that flow of the fluid is substantially prevented through the clearance space S_{C}. Preferably, the predetermined or “closure” pressure is within the range of about twenty pounds per square inch (20 psi) and about twenty-five pounds per square inch (25 psi), but may be within any other appropriate pressure range depending on the specification application of the seal 10. With a presently preferred “operating pressure” (i.e., a pressure sufficient to displace the actuating piston 4) of about three hundred pounds per square inch (300 psi), it is apparent that the pressure chamber(s) C_{P} are fluidly isolated by the seal 10 at a relatively early stage in the process of increasing fluid pressure from the pressure at an inactive state to the operating pressure.

Thus, the seal 10 of the present invention performs the primary function of sealing or obstructing the clearance space S_{C}, so as to substantially prevent fluid flow out of or into the pressure chamber C_{P}, under normal operating pressures while permitting lubrication of the sealing surface 14 during low pressure situations. Thereby, the seal 10 enables a reduction of friction between the seal 10 and the second member 2, which can prevent axial “cocking” of the linearly displaceable member 1 or 2, as described in detail below.

Referring to FIGS. 1 and 7-10, the second member 2 has a circumferential “running” surface 2a against which the sealing surface 14 is slidably disposed/disposeable; that is, the projections 16 always contact the surface 2a and the recessed sections 15 generally contact the surface 2a except at relatively low fluid pressure P. Each lubrication gap G_{L} is radially bounded by the second member circumferential surface 2a and a separate one of the recessed sections 15 of the sealing surface 14. Preferably, each lubrication gap G_{L} has a radial thickness t_{R} between about one thousands of an inch (0.001″) and about ten thousands of an inch (0.010″) when the pressure is lesser than the predetermined pressure P_{C}. Such a gap size permits a sufficient amount of the fluid to pass between the seal body 12 and the second member 2 to lubricate the sealing surface 14 without risk of a substantial, undesired leakage of the fluid out of the pressure chamber C_{P}.

As shown in FIGS. 1 and 7-9, in certain constructions, the seal 10 is an outer seal 11A in which the sealing surface 14 is an outer circumferential surface of the body 12, the body 12 having an inner circumferential surface disposed about an outer circumferential surface 1a of the first member 1. The projections 16 extend generally radially outwardly from the sealing surface 14 and the running surface 2a of the second member 2 is an inner circumferential surface. In such sealing arrangements, the first member 1 may be a clutch actuating piston 4 and the second member 2 may be a housing 5 (e.g., a “clutch drum”) disposed about the piston 4 or the first member 1 may be a balance piston 6 and the second member 2 may be a clutch actuating piston 4 disposed about the balance piston 6. In other constructions, as depicted in FIGS. 1, 6 and 9, the seal 10 is an inner seal 11B in which the sealing surface 14 is an inner circumferential surface 12b of the body 12, the body 12 having an outer circumferential surface disposed against an inner circumferential surface 1b of the first member 1. The projections 16 extend generally radially inwardly from the sealing surface 14 and the running surface 2a of the second member 2 is an outer circumferential surface. In these sealing configurations, the first member 1 may be a clutch actuating piston and the second member 2 may be a shaft 7 extending through the actuating piston 4.

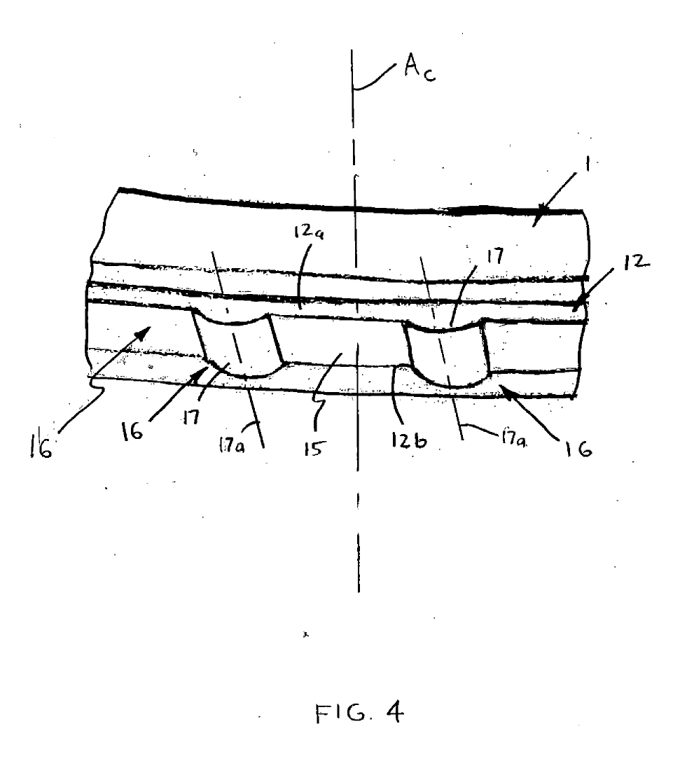

Referring to 2-4, the seal body 12 has opposing axial ends 12a, 12b and each projection 16 preferably extends generally axially between the two body ends 12a, 12b. As such, each projection 16 is generally formed as an axial rib 17 having a centerline 17a extending between the body ends 12a, 12b, and is preferably shaped so as to have a generally semicircular radial cross-sectional shape when not engaged with the second member running surface 2a. In certain constructions as depicted in FIG. 4, each rib centerline 17a is angled relative to the central axis A_{C} such that the projections 16 bias the displaceable one of the first and second members 1, 2 to angularly displace about the axis A_{C} as the member 1 or 2 linearly displaces along the axis A_{C}. Such angled ribs 17 are beneficial in certain actuator assemblies 3 having one or more biasing members 28 (e.g., coil springs) for returning the actuating piston 4 to an initial or non-engaged position.

Specifically, if the biasing member(s) 28 tend to twist or rotate the piston 4 during linear displacement, a proper matching of the angle of the ribs 17 to the direction of the twist caused by the biasing members 28 facilitates the rotation of the piston 4, thereby reducing the chance of the piston 4 becoming “cocked” or skewed with respect to the central axis A_{C}. Further, each projection 16 is preferably formed by molding material onto the sealing body 12, but may be alternatively formed by removing material from the body 12 so that “projections” remain between sections of material removal.

Further, the seal body 12 is preferably formed of an elastomeric material and is most preferably molded or bonded onto the first member 1, which is formed of a metallic material (e.g., low carbon steel). However, the seal body 12 may alternatively be mounted to the first member 1 by any appropriate means, such as with an adhesive, a friction fit, etc. Further, with such an elastomeric body 12, the projections 16 are preferably integrally formed in the molding process to extend radially from a remainder of the body 12.

Referring to FIGS. 1 and 7, in a presently preferred application, the actuator assembly 3 is incorporated into a clutch mechanism 8 for coupling a rotatable shaft 7 with an output member 9. The actuator assembly 3 preferably includes an actuating piston 4 slidably coupled with the shaft 7, a balance piston 6 fixedly connected with the shaft 7 and a clutch pack 30. The clutch pack 30 has at least one and preferably a plurality of first clutching members 30a coupled with the shaft 7 (e.g., through the housing 5) and at least one and preferably a plurality of second clutching members 30b connected with the output member 9. The actuating piston 4 is configured to displace the first and second clutching members into frictional engagement, thereby coupling the shaft 7 with the output member 9 such that the two components 7, 9 rotate as a unit about the central axis A_{C}. A first or “drive” pressure chamber C_{PD} is defined between the actuating piston 4 and the housing 5 and a second or “balance” pressure chamber C_{PB} is defined between the balance piston 6 and the actuating piston 4. A working fluid, most preferably automatic transmission fluid (“ATF”), is disposed within each of the pressure chambers C_{PD}, C_{PB}. The actuating piston 4 is linearly displaceable by fluid pressure in the drive pressure chamber C_{PD} so as to engage with a clutch pack 30, thereby coupling the shaft 7 with the output member 9, and fluid within the balance chamber C_{PB} balances the pressure in the drive chamber C_{PD}) to prevent unintended actuation of the piston 4.

Such an actuator assembly 3 preferably includes three seals 10 formed in accordance with the present invention; specifically, a first seal 20A for sealing the clearance space S_{C1} between the balance piston 6 and the actuating piston 4, a second seal 20B for sealing the clearance space S_{C2} between the actuating piston 4 and the housing 5, and a third seal 20C for sealing clearance space S_{C3} between the actuating piston 4 and the shaft 7. Specifically, with the first seal 20A, the seal body 12 is disposed on the balance piston outer circumferential surface 6a and the sealing surface 14 is engaged with a first inner circumferential surface 4b of the actuating piston 4. Working fluid in the balance chamber C_{PB} exerts pressure on the first seal 20A so as to close the clearance space S_{C1} between the balance and actuating pistons 6, 4. With the second seal 20A, the seal body 12 is disposed on the actuating piston outer circumferential surface 4a and the sealing surface 14 is engaged with, and slides within, an inner circumferential surface 5a of the housing 5. Working fluid in the drive chamber C_{PD} exerts pressure on the second seal 20B so as to close the clearance space S_{C2} between the actuating piston 4 and the housing 5. Further, with the third seal 20C, the body 12 is disposed on the actuating piston inner circumferential surface 4c and the sealing surface 14 is engaged with, and slides upon, a second inner circumferential surface 4c of the actuating piston 4. Working fluid in the drive chamber C_{PD} also exerts pressure on the third seal 20C so as to close the clearance space S_{C3} between the actuating piston 4 and the shaft 7. Each of the three seals 20A, 20B, 20C function in substantially the same manner, except that the first and second seals 20A, 20B are outer seals 11A that deflect radially outwardly under fluid pressure, whereas the third seal 20C is an inner seal 11B which deflects radially inwardly under fluid pressure.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims

I claim:

1. A seal for sealing a clearance space between first and second members disposed generally coaxially about an axis, one of the first and second members being linearly displaceable generally along the axis relative to the other one of the first and second members, the seal comprising:
a generally annular body coupled with the first member, the body having a centerline generally coaxial with the central axis, a sealing surface extending circumferentially about the axis, and a plurality of projections extending generally radially from the sealing surface and into contact with the second member, the projections being spaced circumferentially about the axis so as to define a separate lubrication gap between each pair of adjacent projections, the body being configured to radially deflect when exposed to at least a predetermined fluid pressure such that recessed sections of the sealing surface extending between the projections contact the second member to substantially obstruct the clearance space.

2. The seal as recited in claim 1 wherein each lubrication gap is configured to permit a lubricant to become disposed generally between the sealing surface and the second member when the seal body is exposed to a pressure lesser than the predetermined fluid pressure.

3. The seal as recited in claim 2 wherein the predetermined pressure is within the range of about twenty pounds per square inch and twenty-five pounds per square inch.

4. The seal as recited in claim 1 wherein a pressure chamber is defined generally between the first and second members and the seal body is exposed to pressure of a fluid within the chamber.

5. The seal as recited in claim 1 wherein the second member has a circumferential surface and each lubrication gap is radially bounded by the circumferential surface and a separate one of the recessed sections of the sealing surface.

6. The seal as recited in claim 4 wherein each lubrication gap has a radial thickness between about one thousands of an inch and about ten thousands of an inch when the pressure is lesser than the predetermined pressure.

7. The seal as recited in claim 1 wherein one of:
the sealing surface is an outer circumferential surface of the annular body and the projections extend generally radially outwardly from the sealing surface.
the sealing surface is an inner circumferential surface of the annular body and the projections extend generally radially inwardly from the sealing surface.

8. The seal as recited in claim 1 wherein the projections are formed by one of molding material onto the seal body and removing material from the seal body.

9. The seal as recited in claim 1 wherein the seal body has opposing axial ends and each projection extends generally axially between the two body ends.

10. The seal as recited in claim 9 wherein the each projection has a centerline and each projection centerline is angled relative to the central axis such that the projections bias the one of the first and second members to angularly displace about the axis as the one member linearly displaces along the axis.

11. The seal as recited in claim 1 wherein the seal body is formed of an elastomeric material.

12. The seal as recited in claim 11 wherein the seal body is bonded to the first member.

13. The seal as recited in claim 1 wherein one of:
the sealing surface is an outer circumferential surface, the seal body further includes an inner circumferential surface disposed against an outer circumferential surface of the first member, and the sealing surface is engageable with an inner circumferential surface of the second member to seal the clearance space; and
the sealing surface is inner circumferential surface, the seal body further includes an outer circumferential surface disposed against an inner circumferential surface of the first member, and the sealing surface is engageable with an outer circumferential surface of the second member to seal the clearance space.

14. The seal as recited in claim 1 wherein one of:
the first member is a clutch actuating piston and the second member is a housing disposed about the actuating piston;
the first member is a clutch balance piston and the second member is a clutch actuating piston disposed about the balance piston; and
the first member is a clutch actuating piston and the second member is a shaft extending through the piston.

15. The seal as recited in claim 1 wherein at least one of the first and second members is rotatable about the central axis.

16. An actuator assembly comprising:
first and second members disposed coaxially about a central axis such that a clearance space is defined between the two members, one of the first and second members being an actuator piston linearly displaceable generally along the axis relative to the other one of the first and second members; and
a seal for sealing the clearance space, the seal including a generally annular body coupled with the first member, the body having a centerline generally coaxial with the central axis a sealing surface extending circumferentially about the axis, and a plurality of projections extending generally radially from the sealing surface and into contact with the second member, the projections being spaced circumferentially about the axis so as to define a separate lubrication gap between each pair of adjacent projections, the body being configured to radially deflect when exposed to at least a predetermined fluid pressure such that recessed sections of the sealing surface extending between the projections contact the second member to substantially obstruct the clearance space.

17. The actuator assembly as recited in claim 16 wherein one of:
the first member is a clutch actuating piston displaceable along the central axis and the second member is a housing; and
the first member is a clutch balance piston and the second member is a clutch actuating piston displaceable along the central axis.

18. The actuator assembly as recited in claim 16 wherein a pressure chamber is defined generally between the first and second members, the actuator assembly further comprises a working fluid disposed within the pressure chamber, and the seal body is exposed to pressure of the working fluid within the chamber such that the seal body deflects radially when the working fluid pressure is at least the predetermined pressure.

19. The actuator assembly as recited in claim 16 wherein each lubrication gap is configured to permit a portion of the working fluid to become disposed generally between the sealing surface and the second member when the seal body is exposed to a pressure lesser than the predetermined fluid pressure.

20. The actuator assembly as recited in claim 16 wherein the predetermined pressure is within the range of about twenty pounds per square inch and twenty-five pounds per square inch.

21. The actuator assembly as recited in claim 16 wherein the seal body has opposing axial ends and each projection extends generally axially between the two body ends, each projection has a centerline, and each projection centerline is angled relative to the central axis such that the projections bias the piston to angularly displace about the axis as piston linearly displaces along the axis.

22. The actuator assembly as recited in claim 16 wherein the seal body is formed of an elastomeric material and the seal body is bonded to the first member.

23. The actuator assembly as recited in claim 16 wherein one of:
the sealing surface is an outer circumferential surface, the seal body further includes an inner circumferential surface disposed about an outer circumferential surface of the first member, and the sealing surface is engageable with an inner circumferential surface of the second member to seal the clearance space; and
the sealing surface is inner circumferential surface, the seal body further includes an outer circumferential surface disposed within an inner circumferential surface of the first member, and the sealing surface is engageable with an outer circumferential surface of the second member to seal the clearance space.

24. The actuator assembly as recited in claim 16 further comprising a housing having an inner circumferential surface defining a bore and a rotatable shaft disposed within the bore, the central axis extending centrally through the shaft, and wherein:
the first member is a balance piston mounted on the shaft and having an outer circumferential surface;
the seal body is disposed on the balance piston outer circumferential surface; and
the second member is an actuating piston slidably mounted on the shaft and having inner circumferential surface, the sealing surface being engageable with the actuating piston inner surface.

25. The actuator assembly as recited in claim 17 wherein:
the seal is a first seal;
the actuator piston has an outer circumferential surface spaced radially inwardly from the housing inner surface to define a second clearance space and another inner circumferential surface, the other inner circumferential surface being spaced radially outwardly from the shaft so as to define a third clearance space;
the actuator assembly further comprises second and third seals;
the second seal has a generally annular body coupled with the actuating piston, the second seal body having a centerline generally coaxial with the central axis, a sealing surface extending circumferentially about the axis, and a plurality of projections extending generally radially outwardly from the second sealing surface and into contact with the housing inner surface, the projections being spaced circumferentially about the axis so as to define a separate lubrication gap between each pair of adjacent projections, the second seal body being configured to radially deflect when exposed to at least a predetermined fluid pressure such that recessed sections of the second sealing surface extending between the projections contact the housing to substantially obstruct the second clearance space; and
the third seal has a generally annular body coupled with the actuating piston, the third seal body having a centerline generally coaxial with the central axis, a third sealing surface extending circumferentially about the axis, and a plurality of projections extending generally radially inwardly from the third sealing surface and into contact with the shaft, the projections being spaced circumferentially about the axis so as to define a separate lubrication gap between each pair of adjacent projections, the third seal body being configured to radially deflect when exposed to at least a predetermined fluid pressure such that recessed sections of the third sealing surface extending between the projections contact the shaft to substantially obstruct the third clearance space.
